(19) United States
(12) Patent Application Publication
(10) Pub. No.: US 2026/0018171 A1
(43) Pub. Date: Jan. 15, 2026

(54) AUDIO PROCESSING METHOD AND SYSTEM

(71) Applicant: Sony Interactive Entertainment Inc., Tokyo (JP)

(72) Inventors: Adrian Barahona Rios, London (GB); Jason Craig Millson, London (GB); Nicholas Anthony Edward Ryan, London (GB); Ryan John Spick, London (GB); Alan Suganuma Murphy, London (GB)

(73) Assignee: Sony Interactive Entertainment Inc., Tokyo (JP)

(21) Appl. No.: 19/261,210

(22) Filed: Jul. 7, 2025

(30) Foreign Application Priority Data
Jul. 10, 2024 (GB) 2410034.9

(51) Int. Cl. G10L 15/25; G06F 3/01; G10L 13/02; G10L 15/06; G10L 15/22

(52) U.S. Cl. CPC G10L 15/25; G06F 3/017; G10L 13/02; G10L 15/063; G10L 15/22; G06F 2203/011; G10L 2015/227; G10L 2015/228

(57) ABSTRACT

There is provided an audio processing method for assisting communication between a plurality of users of a videogame. The method comprises: receiving, from one or more sensors, data relating to one or more lip movements of a first user of the plurality of users; detecting a game state of the videogame; determining, using a machine learning model, an intended speech input by the first user in dependence on: the data relating to lip movements of the first user, and the game state; generating an audio signal corresponding to the intended speech input by the first user; and outputting the audio signal to a device of a second user of the plurality of users.

### BACKGROUND OF THE INVENTION

### Field of the Invention

The present invention relates to an audio processing method and system for assisting communication between a plurality of users of a videogame.

### Description of the Prior Art

The popularity of multi-player videogames has increased in recent years. Such multi-player video games allow users to connect with other users while completing certain achievements or challenges within the videogame. For example, in order to complete certain achievements or challenges within a multi-player videogame, two or more users may need to co-operate with each other. For example, the two or more users may need to help each other in order to overcome a certain obstacle or defeat a mutual enemy. In other examples, completing certain achievements or challenges may require the two or more users to compete with each other. For example, the two or more users may be split into two or more teams, and the challenge is to obtain more points, kills, goals, etc. than the other team(s).

While playing a multi-player videogame, users may communicate with each other either to discuss strategies for completing a certain achievement or challenge, or for social interaction and camaraderie. In single-player videogames, a playing user may similarly communicate with non-playing spectators. This communication is typically achieved using communication methods such as Voice over Internet Protocol (VoIP), or the like, which enable users, playing or spectating, to talk to each other during gameplay.

However, certain users may find communicating with other users in this manner difficult. This can be the result of users having inadequate equipment (e.g. poor quality headphones or microphones) or being in inadequate environments (e.g. that are too noisy) for voice chat. Alternatively, or in addition, users may find communication over voice chat difficult due to speech issues, cognitive issues, not being able to speak fluently in the language being used to communicate, or the like.

These users may therefore be limited to communicating via text chat which may be easier to understand. However, text chat can be distracting for users and reduce their sense of immersion in the game.

The present invention seeks to mitigate or alleviate these problems.

### SUMMARY OF THE INVENTION

Various aspects and features of the present invention are defined in the appended claims and within the text of the accompanying description and include at least: In a first aspect, an audio processing method is provided in accordance with claim 1. In another aspect, an audio processing system is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 is a schematic flowchart illustrating a method of assisting communication between users of a videogame;

FIG. 3 schematically illustrates a device of a first user for use in the method of assisting communication;

FIG. 4 schematically illustrates a device of a second user for use in the method of assisting communication;

### DESCRIPTION OF THE EMBODIMENTS

An audio processing (and/or audio generation) method and system are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In an example embodiment of the present invention, a suitable system and/or platform for implementing the methods and techniques herein may be an entertainment system.

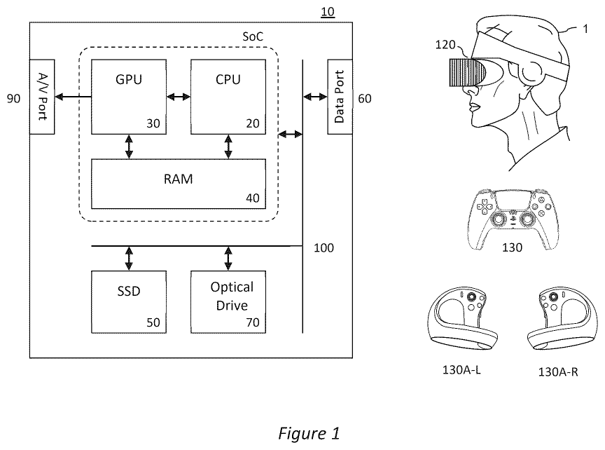

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

The CPU 20 and/or GPU 30 are examples of processors that the entertainment system 10 may use to render images. Alternatively, or in addition, one or more further processors (internal and/or external to the entertainment system 10) may be provided for rendering images.

Further storage may be provided by a disk 50, either as an external or internal hard drive, or as an external solid state drive, or an internal solid state drive.

The entertainment system may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment system are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD. The user typically interacts with the system, and any content displayed, or rendered, by the system, by providing inputs via the handheld controllers 130, 130A. For example, when playing a game, the user may navigate around the game virtual environment by providing inputs using the handheld controllers 130, 130A.

Embodiments of the present disclosure relate to use of a trained machine learning (ML) model to determine an intended speech input by a user. The machine learning model may be trained using various techniques, such as supervised learning and/or unsupervised learning.

In one or more example embodiments of the present disclosure, the machine learning model may be trained using supervised learning. Such a machine learning model may be referred to as a supervised (machine) learning model.

The supervised learning model is trained using labelled training data to learn a function that maps inputs (typically provided as feature vectors) to outputs (i.e. labels). The labelled training data comprises pairs of inputs and corresponding output labels. The output labels are typically provided by an operator to indicate the desired output for each input. The supervised learning model processes the training data to produce an inferred function that can be used to map new (i.e. unseen) inputs to a label.

The input data (during training and/or inference) may comprise various types of data, such as numerical values, images, video, text, or audio. Raw input data may be pre-processed to obtain an appropriate feature vector used as input to the model—for example, features of an image or audio input may be extracted to obtain a corresponding feature vector. It will be appreciated that the type of input data and techniques for pre-processing of the data (if required) may be selected based on the specific task the supervised learning model is used for.

Once prepared, the labelled training data set is used to train the supervised learning model. During training the model adjusts its internal parameters (e.g. weights) so as to optimize (e.g. minimize) an error function, aiming to minimize the discrepancy between the model's predicted outputs and the labels provided as part of the training data. In some cases, the error function may include a regularization penalty to reduce overfitting of the model to the training data set.

The supervised learning model may use one or more machine learning algorithms in order to learn a mapping between its inputs and outputs. Example suitable learning algorithms include linear regression, logistic regression, artificial neural networks, decision trees, support vector machines (SVM), random forests, and the K-nearest neighbour algorithm.

Once trained, the supervised learning model may be used for inference—i.e. for predicting outputs for previously unseen input data. The supervised learning model may perform classification and/or regression tasks. In a classification task, the supervised learning model predicts discrete class labels for input data, and/or assigns the input data into predetermined categories. In a regression task, the supervised learning model predicts labels that are continuous values.

In some cases, limited amounts of labelled data may be available for training of the model (e.g. because labelling of the data is expensive or impractical). In such cases, the supervised learning model may be extended to further use unlabelled data and/or to generate labelled data.

Considering using unlabelled data, the training data may comprise both labelled and unlabelled training data, and semi-supervised learning may be used to learn a mapping between the model's inputs and outputs. For example, a graph-based method such as Laplacian regularization may be used to extend a SVM algorithm to Laplacian SVM in order to perform semi-supervised learning on the partially labelled training data.

Considering generating labelled data, an active learning model may be used in which the model actively queries an information source (such as a user, or operator) to label data points with the desired outputs. Labels are typically requested for only a subset of the training data set thus reducing the amount of labelling required as compared to fully supervised learning. The model may choose the examples for which labels are requested—for example, the model may request labels for data points that would most change the current model, or that would most reduce the model's generalization error. Semi-supervised learning algorithms may then be used to train the model based on the partially labelled data set.

One or more example embodiments of the present invention may use generative artificial intelligence (AI) systems and techniques. For example, generative AI may be used to generate an audio speech signal for a text input.

A generative AI (i.e. generative machine learning) system learns patterns and structures in its input training data, in order to then generate new output data which exhibits similar characteristics to the training data. Each of the input training data and output data may comprise various types of data, such as images, video, text, or audio. For example, the generative AI system may learn patterns in input training images, and then generate images that have similar characteristics.

The generative AI system may generate output data based on an input prompt. Like the training and output data, the prompt may comprise various types of data, such as images, video, text, or audio. The prompt may be of the same or different data type to the model's training and/or output data. For example, the input prompt may comprise text and the output data may comprise an image (e.g. matching an input text description of a desired image), or the input prompt may comprise an image and the output data may comprise audio data (e.g. with a theme matching the input image).

The generative AI system may comprise a generative model trained to learn a probability distribution of the input training data, and generate new output data based on this learned distribution. For example, for a set of data instances/observable variables (X) and a set of labels/target variables (Y) in the training data set, the generative model may learn a joint probability distribution of data instances and labels p(X,Y), and/or a probability distribution of the data instances p(X) (for example where no labels are available).

Example suitable generative models for learning a probability distribution of the input training data include Variational Autoencoders (VAEs), transformer-based models, diffusion models (e.g. denoising diffusion probabilistic models (DDPMs)), Reinforcement Learning (RL), and Generative Adversarial Networks (GANs). The choice of generative model may depend on the specific task performed by the generative AI system.

The generative model may comprise one or more artificial neural networks. For example, a Variational Autoencoder (VAE) may comprise a pair of neural networks acting as an encoder and a decoder to and from a reduced (i.e. latent space) representation of the training data respectively, and a Generative Adversarial Network (GAN) may comprise a first ‘generator’ neural network that generates new data and a second ‘discriminator’ neural network that learns to discriminate between generated data and real data. The one or more constituent neural networks of the generative model may be trained together or separately.

During training the generative model may adjust its internal parameters (e.g. neural network weights) so as to optimize (e.g. minimize) a loss/error function, aiming to minimize discrepancy between the generated output data and desired output data. It will be appreciated that the specific loss function, and algorithm used to optimize the function may vary depending on the nature of the generative model, and its intended application. For example, a mean squared error loss function may be used for an image generation task, and a cross-entropy loss function may be used for a text generation task. These loss functions may be optimized using various existing optimization algorithms, such as gradient descent.

Once trained, the generative model may be used to generate new output data based on an input prompt. The input prompt may be provided by a user, or by an appropriate device (e.g. using an application programming interface (API)). Thus, the generative AI system allows generating new content (e.g. images, text, or audio) based on only a prompt and without requiring detailed instructions for doing so.

As mentioned, certain users may find communicating with others users difficult for various reasons, such as having inadequate equipment, speech issues, cognitive issues, or noise in their environment. However, existing arraignments for non-verbal communication, such as text chats, can be distracting for users and reduce their sense of immersion in the game.

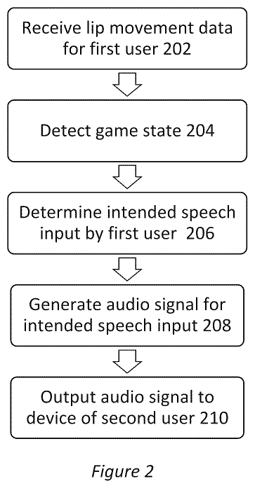

Referring to FIG. 2, embodiments of the present disclosure relate to an audio processing method for assisting communication between a plurality of users of a videogame. In the present method, a game state of the videogame is detected 202, and data relating to one or more lip movements of a first user of the plurality of users (e.g. a first player in a multi-player videogame) is received 204 from one or more sensors (e.g. an image sensor). An intended speech input by the first user is then determined 206 using a machine learning (ML) model in dependence on the data relating to lip movements of the first user, and on the detected game state. Subsequently, an audio signal corresponding to the intended speech input by the first user is generated 208 (e.g. using generative AI techniques as described herein) and output 210 to a device of a second user of the plurality of users (e.g. a second player in the multi-player videogame, such as a teammate of the first player).

In this way, the present method allows users to more easily communicate with one another, and to do so in a more intuitive manner that, unlike e.g. text chats, does not occupy screen space or distract users from the videogame. By determining the intended speech input by the first user using the ML model at least partly based on game state data (e.g. recent events in the videogame), the present method allows more accurately identifying what information the first user intended to convey, which is particularly beneficial for users that have trouble with speech communication, e.g. for the various reasons described herein. Further, this identification process can be performed in the ‘background’ in a manner that does not require any further actions from the user other than those normally already provided in audio chat; where the only required user input is their lip movements which the user can e.g. provide by mouthing or quietly saying their intended message. The present approach therefore allows the first user to more easily communicate their intended message to other users.

Furthermore, by generating an audio signal corresponding to the intended speech input by the first user, the present invention allows the second user to more easily understand the intended message by the first user as the audio signal can be generated in a manner that facilitates its understanding by the second user. For example, the audio signal can be generated in a clear, legible voice (thus effectively hiding speech impediments of the first user), or further personalised for the second user, e.g. by translating the intended message to the second user's mother tongue.

The present approach therefore provides a communication method that has the benefits of voice communication, such as its convenience and intuitiveness for users, while addressing the challenges and difficulties associated with voice communication faced by certain users. The present approach provides a new communication mechanism that allows users to retain the benefits of voice communication while allowing users to communicate quietly or without making sounds, e.g. when playing a game at night or in the same room as a sleeping child. The present invention therefore can be considered as providing a ‘silent’ voice chat communication method for users.

The present invention can further improve the efficiency of audio communication between users by reducing the communication load on the devices involved. In particular, the intended speech input can be detected locally (e.g. at the first user's device or at a server) and transmitted as text data to the second user's device which then generates a corresponding audio signal thus reducing the amount of data that needs to be transmitted to the second user's device.

The term “user” as used herein in relation to a videogame preferably connotes a user interacting with the videogame. The interaction may comprise two-way interaction where users provide inputs to the videogame and/or one-way interactions where users only view or spectate the videogame. The term “user” may therefore encompass players of the videogame, and/or spectating users.

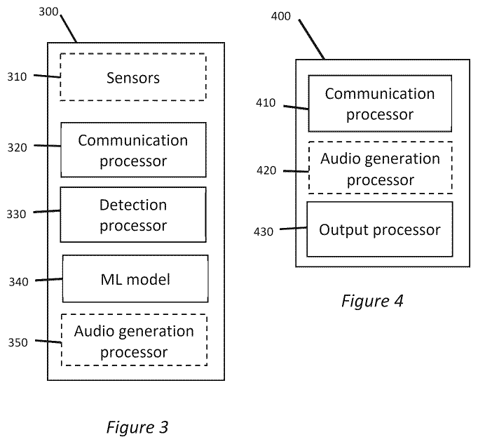

Referring to FIGS. 3 and 4, these figures show example apparatuses that may form an audio processing system in accordance with embodiments of the present disclosure.

FIG. 3 schematically illustrates a first data processing apparatus 300 in accordance with embodiments of the disclosure. The first data processing apparatus 300 may for example comprise a device of a first user of a plurality of users of a videogame, such as the first user's personal computer or entertainment system 10, and/or a gaming server in communication with devices of both the first and second users.

FIG. 4 schematically illustrates a second data processing apparatus 400 in accordance with embodiments of the disclosure. The second data processing apparatus 400 may comprise a device of a second user of the videogame, such as the second user's personal computer, or entertainment system 10 and/or a gaming server in communication with devices of both the first and second users. It will therefore be appreciated that in some cases both the first and second data processing apparatuses may be implemented by a single device or entity (such as a server).

The first data processing apparatus 300 comprises a communication processor 320, a detection processor 330, and an ML model 340. The communication processor 320 receives data relating to one or more lip movements of a first user of a videogame from one or more sensors. The detection processor 330 detects a game state of the videogame (e.g. data relating to one or more characteristics of an in-game character being controlled by the first user, or to a viewpoint of a virtual camera associated with the first user). The ML model 340 then determines an intended speech input by the first user in dependence on the data relating to lip movements of the first user received by the communication processor 320, and the game state detected by the detection processor 330. The ML model 340 (e.g. the weights of a neural network constituting the ML model) may for example be stored in memory on the first data processing apparatus 300.

The first data processing apparatus 300 may optionally further comprise the one or more sensors 310 that capture data relating to one or more lip movements of the first user, and/or an audio generation processor 350 that generates an audio signal corresponding to the intended speech input by the first user as determined by the ML model 340.

The sensors 310 may therefore be provided as part of the first data processing apparatus 300. Alternatively, the sensors may be provided separately to the first data processing apparatus 300 (e.g. as part of a separate sensing device) and data captured by the sensors, optionally at least partly processed, may be transmitted to the first data processing apparatus 300. In cases where the audio generation processor 350 is provided as part of the first data processing apparatus 300, the generated audio signal may be transmitted by the communication processor 320 to the second data processing apparatus 400.

The communication processor 320 further transmits data to the second data processing apparatus 400 for outputting an audio signal corresponding to the intended speech input by the first user.

The second data processing apparatus 400 comprises a communication processor 410 and an output processor 430. The communication processor 410 receives data from the communication processor 320 of the first data processing apparatus 300. For example, the communication processor 410 may receive data relating to the intended speech input by the first user (e.g. as text data) as determined by the ML model 340, or an audio signal corresponding to the intended speech input as generated by the audio generation processor.

The output processor 430 outputs the audio signal to the second user's device. This may comprise transmitting the audio signal to the second user's device, e.g. in cases where the second data processing apparatus comprises a gaming server. Alternatively, for instance in cases where the second data processing apparatus comprises the second user's device, this may comprise outputting the audio signal at the second user's device, e.g. using a loudspeaker.

The second data processing apparatus 300 may optionally further comprise an audio generation processor 420 that generates an audio signal corresponding to the intended speech input by the first user based on data received by the communication processor 410.

Generation of the audio signal may therefore be performed at least in part on one or both of the first data processing apparatus 300 and the second data processing apparatus via their respective audio generation processors 350, 420.

As noted above, at least part of the functionality of the various processors 310-350, 410-430 may be performed by a game server in communication with devices of the first and second users. In this way, the computational load of the respective operations may be moved from the devices to the server. The gaming server may for example comprise a cloud server for the videogame.

Referring back to FIG. 2, this shows an example of an audio processing method in accordance with one or more embodiments of the present disclosure. This audio processing method may for example be implemented by the first data processing apparatus 300 and the second data processing apparatus 400 of FIGS. 3 and 4. Alternatively, the audio processing method may be implemented by an entertainment system 10 as described with reference to FIG. 1, e.g. by the entertainment system 10 of the first and/or second user.

The steps of the audio processing method of FIG. 2 will now be described in further detail.

A step 202 comprises receiving, from one or more sensors, data relating to one or more lip movements of a first user of the plurality of users. The data received from the sensors provides non-auditory indicators of the intended speech input by the first user, which may be used for lip reading of the first user. This data may be received from the sensors using any suitable communication means.

The sensors capture data relating to lip movements of the first user (i.e. ‘lip movement’ data for the first user). The lip movement data may comprise data relating to movements of the lips of the first user. The lip movement data may comprise data relating to movements of the tongue of the first user, and/or facial expressions of the first user, which can further guide the detection of the user's intended speech input. For the same reasons, in some cases, the lip movement data may further comprise data relating to gestures and/or body language of the first user.

The one or more sensors (e.g. sensors 310 of the first data processing apparatus 310) may comprise one or more of: an image sensor, a depth sensor, an electrical sensor, a motion sensor, and/or an infrared sensor. It will also be appreciated that a plurality of a given type of sensor may be used, e.g. two image sensors may be used; and that any combination of these, or other suitable, sensors may be used.

One or more of the image sensor, depth sensor, and/or infrared sensor may be arranged at a distance from the first user, for example as part of the videogame console of the first user, or one of its peripheral devices. The image sensor may for example comprise a video camera that captures a plurality of images of the first user's face, including lip movements of the user. Similarly, the depth sensor (e.g. time of flight sensor) may capture data relating to the three-dimensional shape of the user's face at a plurality of time points, to identify lip movements of the user. The infrared sensor may capture data relating to the heat distribution across the user's face which may for example help identify heat signatures at certain positions on the user's face indicating specific facial expression or lip movements.

The electrical sensor and/or motion sensor may be arranged more proximate the first user, for example as part of a head mounted display (HMD) worn by the user. The electrical sensor may for example comprise an electromyography sensor arranged on the user's face that detects the electrical activity generated by facial muscles of the user. The motion sensor may for example comprise an accelerometer or gyroscope that capture data relating to the movement and orientation of the user's head and face.

In some cases, the one or more sensors may capture data relating to facial expressions and/or body language of the first user, which data may be received as part of the lip movement data at step 202. Data relating to facial expressions and/or body language (e.g. face movements, or gestures) may for example be captured using a camera arranged to face the first user and/or motion sensors attached to the user. The intended speech input may then be determined at step 206 in dependence on lip movements of the first user, and the facial expressions and/or body language of the first user. This allows further improving the accuracy of determining the intended speech input as the facial expression and body language provide additional contextual cues that the ML model can learn to recognise when determining what the user intended to say.

A step 204 comprises detecting a game state of the videogame. As discussed with reference to step 206, detecting the game state allows improving the accuracy of determining the first user's intended speech input, by providing contextual cues to the ML model that learns to predict likely speech inputs at various game states. Detecting the game state may comprise extracting information about the game state from the videogame application, and/or from a gaming server.

The detected game state comprises data relating to the current state of the videogame. The detected game state may comprise one or more of: character data, event data, position data, virtual camera data, interaction data, objective data, proficiency data, videogame data, and/or profile data. Character data may relate to one or more characteristics of an in-game character being controlled by the first user and/or by one or more other users of the plurality of users of the videogame (e.g. the type of the in-game character (e.g. wizard, or knight), or the in-game character's current properties such as health). Event data may relate to one or more events that have occurred in gameplay of the videogame (e.g. a fight between the first user and a non-playing character (NPC), or the first user reaching a checkpoint within the game). Position data may relate to a position (e.g. location and/or motion) of one or more in-game characters and/or one or more in-game objects within a virtual environment of the video game, such as data relating to objects within a predetermined distance of the first user's in-game character. Virtual camera data may relate to a viewpoint of a virtual camera associated with the first user, which may for example indicate which objects are in the first user's viewpoint. Interaction data may relate to one or more in-game (non-player or player controlled) characters and/or in-game objects with which the first user has been interacting, either prior to or concurrently with the data relating to lip movements being received. Objective data may relate to one or more in-game objectives associated with the first user and/or one or more in-game objectives associated with one or more other users of the plurality of users, e.g. a destination that the first user is required to reach in the videogame. Proficiency data may relate to a proficiency with which the first user plays the video game and/or a proficiency with which one or more other users of the plurality of users play the video game, for example each user in the videogame may be assigned a proficiency score that indicates their current level and that is updated based on the user's recent gameplay. Videogame data may relate to at least one of a type of the videogame, a category of the videogame, and a genre of the videogame. Profile data may relate to a gaming profile of the first user and/or gaming profiles of one or more other users of the plurality of users.

It will be appreciated that any combination of the above types of information may be detected as part of detecting the game state. It will also be appreciated that these examples are not exhaustive; persons skilled in the art will appreciate that the game state data may comprise types of information other than those mentioned herein.

A step 206 comprises determining, using a machine learning model, an intended speech input by the first user in dependence on: the data relating to lip movements of the first user, and the game state.

By considering both the data relating to lip movements of the first user received at step 202 and the game state detected at step 204, the intended speech input by the first user can be more accurately determined, facilitating improved communication between the first user and other users of the videogame.

The machine learning model may for example comprise one or more artificial neural networks. It will be appreciated that the ML model may comprise a plurality of layers, and/or sub-models.

Determining the intended speech input by the first user may comprise inputting the data relating to lip movements of the first user and the game state to a machine learning model that predicts the intended speech input. In other words, the machine learning model may be trained to determine an intended speech input of the first user based on inputs comprising both the lip movement data and the game state data. The ML model may be trained to associate features of the game state and the lip movements with user speech inputs.

Considering the lip movement data, the way in which this data is processed by the ML model may depend on the type of data received. For example, in cases where the lip movement data comprises image data (and/or infrared and/or depth data), the ML model may use computer vision techniques to analyse the image data and identify the user's intended speech input. The ML model may for example comprise one or more of hidden Markov models, deep neural networks, or recurrent neural networks configured to process the input image data for outputting an intended speech input. Electrical and/or motion data may be fed into the ML model as a further guiding signal alongside the image data to further inform the detection of the intended speech input. Alternatively, the ML model may be trained to determine the intended speech input based on electrical data and/or motion without the use of image data.

Using the game state data, in addition to the lip movement data, in the prediction of intended speech input improves the accuracy of speech detection as the game state provides additional context for identifying what the user intended to say. Considering the various examples of game state data discussed herein, the ML model may learn to identify what speech inputs are more likely at various game states, e.g. to reduce speech input determinations that may reflect the lip movement data alone but would be unlikely at the current game state.

For example, in cases where the game state comprises character data, the ML model may learn what speech inputs are more likely depending on the type of character controlled by the first user. For instance, in a fantasy role playing game (RPG) the first user may provide different inputs when the first user is controlling a wizard character than when controlling a warlock character. The speech inputs provided by a user may similarly differ depending on the health level of the character controlled by the user, where for example the user may provide more agitated inputs when the health level is low.

Alternatively, or in addition, in cases where the game state comprises event data, the ML model may learn how users comment on various events in games to more accurately identify intended speech inputs. For example, the ML may learn how users react to the death of their character in the game, and use this knowledge to better predict intended speech inputs when the current game state reflect this event. Alternatively, or in addition, in cases where the game state comprises position data, the ML model may learn how users typically comment on objects in their vicinity or their surrounding more generally (e.g. different inputs may be more likely if the user is located at the edge of the game map than at its centre as fewer possibilities for action are available to the user). Alternatively, or in addition, in cases where the game state comprises virtual camera data and/or interaction data, the ML model may learn to assign a higher likelihood to speech inputs associated with (e.g. describing) objects within the user's field of view, and/or to speech inputs associated with recent interactions in the gameplay, than to other possible speech inputs. Similarly, in cases where the game state comprises objective data, the ML model may learn to assign a higher likelihood to speech inputs associated with (e.g. describing) the current objectives in gameplay than to other possible speech inputs (e.g. the objective may be to reach a given destination, and the ML model may assign a higher likelihood to inputs relating to the given destination's name). Alternatively, or in addition, in cases where the game state comprises proficiency data and/or videogame data, the ML model may learn what inputs are used by users of different proficiency levels and/or playing different videogames. For instance, advanced users playing a football game may typically provide different inputs than beginner users playing a first person shooter game. Alternatively, or in addition, in cases where the game state comprises profile data, the ML model may learn correlations between characteristics of the first user (e.g. nationality, or age) and their typical speech inputs.

The ML model may use the input game state and lip movement data to determine the intended speech input by the first user in one or more stages. For example, in a single stage example, the lip movement data and the game state data may be provided to the ML model as part of an input feature vector. In this example, the ML model may process both the game state data and the lip movement data in conjunction to output a predicted intended speech input.

Alternatively, in a multi stage example, the lip movement data and the game state data may be used in different stages of the determination of the intended speech input by the first user. In this example, determining the intended speech input by the first user may comprise determining a plurality of likely intended speech inputs by the first user in dependence on the data relating to lip movements of the first user, and selecting the intended speech input amongst the plurality of likely intended speech inputs in dependence on the game state. For example, the ML model may output the three or five most likely intended speech inputs based on the lip movement data, and one of these may be selected for output in dependence on the game state data. The selection of an intended speech input amongst the likely intended speech inputs may be performed by a further ML model trained to select a speech input that is most likely for a given game state. The further ML model may for example be trained using imitation learning, to imitate such selection being performed by a human operator. The training data for the further ML model may comprise sets of potential intended speech inputs and game states as inputs, and operator selections of intended speech inputs amongst the sets as outputs.

It will be appreciated that the selection of an intended speech input from amongst the plurality of likely intended speech inputs may be performed on the basis of all or part of the speech inputs. The selection may for instance be performed on the basis of one or more phrases, sentences, words, and/or syllables within the speech inputs. For example, the ML model may output a set of complete phrases as the likely speech inputs and an intended speech input may be selected from within that set based on game state data for direct output as the determined intended speech input. Alternatively, the predicted likely intended speech inputs by the ML model may be broken down into smaller sub-parts (e.g. individual words) and one of each of those sub-parts may be selected based on the game state data.

In some cases, the order of the multi stage prediction may also be reversed. The first stage may comprise determining likely intended speech inputs based on the game state, and a second stage may comprise determining the most likely of those speech inputs based on the lip movement data.

It will be appreciated that the lip movement data and/or the game state data may be pre-processed to extract features from the data before it is input to the ML model. For example, as discussed elsewhere herein, the game state may be pre-processed to classify the current game state into one or more game state clusters on the basis of which an ML model is selected for determining the intended speech input based on the received lip movement data.

For example, the lip movement data may be pre-processed to determine a sentiment of the first user. The sentiment of the first user may be determined using a trained machine learning model in dependence on the lip movement data. The sentiment may for example be determined as a score for one or more sentiment categories (e.g. happiness, angriness, sadness). The determined sentiment may then be provided as an input to the ML model, e.g. as one of the features of an input feature vector. Using the first user's sentiment allows training the ML model to determine the user's intended speech input yet more accurately. In some cases, the user's sentiment may be further determined based on eye tracking data (e.g. as received from an HMD operated by the user).

In another example, determining the intended speech input by the first user may comprise selecting one of a plurality of machine learning models for determining an intended speech input of a user in dependence on the game state, and inputting the data relating to lip movements of the first user to the selected machine learning model to determine the intended speech input by the first user. In other words, the game state may be used to select one of a plurality of ML models for subsequent use in determining the intended speech input based on the lip movement data. This advantageously simplifies training of the plurality of ML models as it allows the use of lip reading training data that is unrelated to games, which may be more accessible in large quantities.

The selection of the ML model amongst the plurality of ML models may be performed in a variety of ways. For example, the selection may be performed on the basis of empirically determined rules mapping game states to one of the ML models. For instance, it may be empirically determined that a given ML model performs better at intended speech input detection when the game state indicates that the character controlled by the user has just died or has low health (e.g. as indicated by the character data or event data in the game state data).

Alternatively, or in addition, the selection of the ML model may be performed by a further ML model. The further ML model may for example cluster the game states based on similarities in characteristics of speech inputs provided at those game states. The available ‘lip reading’ ML models (i.e. ML models that determine speech inputs based on lip movement data) may then each be tested for the different game state clusters and the best performing ML model selected for use at inference when the current game state falls within the corresponding game state cluster.

In some cases, alternatively or in addition to selecting the ML model based on the game state, the ML model may be selected based on one or more characteristics of the first user. These characteristics may for example include the user's nationality or age (e.g. as indicated by profile data in the game state data), and/or a facial profile of the first user.

Considering the facial profile of the first user, determining the intended speech input by the first user may comprise selecting one of the plurality of ML models for determining an intended speech input of a user, in dependence on a facial profile of the first user, and then inputting the data relating to lip movements of the first user, and the game state to the selected ML model. The facial profile of the first user may be determined based on data received from the one or more sensors at step 202. For example, the facial profile of the first user may be classified into one of a plurality of facial profile clusters in dependence on received images of the first user's face. Each facial profile cluster may have an associated ML model to be selected for determining the intended speech input based on game state and lip movement data.

Training of the ML model may comprise inputting training data to a machine learning algorithm, training an ML model using the machine learning algorithm based on the training data, and outputting a trained ML model. Any suitable machine learning algorithm may be used for training of the ML model, such as linear regression, or artificial neural networks.

The ML model is trained to predict the intended speech input of a user based on data relating to lip movements of the user and the game state of the game being played by the user. As described below, the training may for example be performed on the basis of a labelled data set comprising pairs of input lip movement and game state data, and corresponding output speech inputs by users. The ML model trained in this way may then be output for use in inference, as described herein.

The training data input to the machine learning algorithm may comprise data relating to speech inputs of a plurality of users of videogames at a plurality of game states, and data relating to lip movements of the plurality of users when providing the speech inputs.

The training data may comprise labelled training data comprising pairs of inputs and corresponding output labels. The training data may comprise, as inputs, the lip movement and game state data for a plurality of users at a plurality of game states; and, as output labels, the speech inputs provided by the users at those game states. The speech inputs may e.g. be detected using a microphone, for example provided as part of a videogame controller, and may be converted to text using suitable audio processing techniques.

Training data may for example be collected during gameplay of a plurality of users, by storing the game state and lip movement data corresponding to each speech input provided by the users. In this way, data for different game states and lip movement can be collected.

In some cases, the training data may comprise separate subsets of data of different size, each used at a different stage of training of the ML model. For example, training the ML model may comprise a first training step based on a larger first training data set, and a second training step based on a second, smaller, training data set. As discussed in further detail below, this allows training the ML model more efficiently and simplifies the collection of training data.

The first training data may comprise for a first plurality of users of videogames, data relating to speech inputs of the users at a plurality of game states, to predict a speech input in dependence on a game state. This data can be easily obtained from recorded gameplay of users providing speech inputs, with no dedicated sensors for capturing lip movement data being required. Thus, a large first training data set can be easily obtained. After the first training step, the ML model is able to provide a (typically relatively rough) prediction of a user's speech input based on game state only. In some cases, text inputs by users may be used alternatively, or in addition, to speech inputs as part of the first training data. This is advantageous as training text input and game state pairs may be yet more easily obtainable for the first training step.

The second training step allows refining this prediction but using a smaller dataset to simplify the training and the collection of the training data as a whole. The second training data may comprise, for a second plurality of users of videogames, data relating to speech inputs of the users at a plurality of game states and data relating to lip movements of the users when providing the speech inputs, to predict a speech input in dependence on lip movements of a user and a game state. There may be fewer users in the second plurality of users than in the first plurality of users, thus reducing the amount of data regarding lip movements (which might require additional sensors) that needs to be collected for training of the ML model. For example, there may be at least 2, 5, 10, 100, or 1000 times fewer users in the second plurality of users than in the first plurality of users.

The second plurality of users may comprise a subset of the first plurality of users, or the second plurality of users may be distinct to the first plurality of users. In the second training step, the ML model learns how to further incorporate lip movement data in its prediction of speech inputs. However, as the ML model is already pre-trained based on game state at the first training step, a smaller amount of training data is required for this second training step. This can allow greatly simplifying the collection of training data, as the first training data can be easily obtained in large quantities using recorded gameplay only, and lip movement data only needs to be collected in smaller quantities for a smaller set of test/training users.

It will be appreciated that the data comprised in the first and second training data sets may depend on how the ML model is used at inference. For example, in the multi-stage inference example described herein, the first training data set may comprise for a first plurality of users, data relating to lip movements and corresponding speech inputs of the users, to predict a speech input in dependence on lip movement data; and the second training data set may comprise for a second plurality of users of videogames, data relating to speech inputs of the users at a plurality of game states (and optionally data relating to lip movements of the users when providing the speech inputs), to select a speech input amongst the likely speech inputs in dependence on game state. This allows improving the efficiency of training the ML model and simplifies the collection of training data as the first and second training data sets can be more easily obtained. In particular, the first plurality of users may comprise any users and may not be users of videogames so any training data relating to lip movements can be used without requiring game-specific training data.

In examples where the game state is used to select one of a plurality of ML models for subsequent use in determining the intended speech input based on the lip movement data, similarly a training data set of users that may be unrelated to games can be used to train each of the plurality of ML models, thus facilitating the collection of training data for the models.

In some cases, the ML model may be calibrated for one or more specific users. This allows improving the accuracy of determining intended speech inputs by users. For example, the ML model may be calibrated based on previous speech inputs provided by the first user. Data relating to speech inputs and game states when providing the speech inputs for a plurality of historical speech inputs by the first user may be used to at least partly re-train the ML model to calibrate the ML model for the first user. This training data may be obtained by processing recorded gameplay to extract speech inputs by the first user and the game state when the speech inputs were provided. The historical speech input data for the first user may be assigned a higher weighting in the training of the ML model than other training data. To reduce overfitting to the historical speech input data set for the first user, the calibration/re-training of the ML model may be limited, e.g. where the ML model comprises an artificial neural network, the adjustment of weightings of the network may be allowed only up to a predetermined threshold (e.g. 1%, 2%, 5% or 10%). The data used for re-training of the ML model for the first user may also comprise lip movement data for the historical speech inputs by the first user, for example as obtained when using the ML model at inference for the first user.

In some cases, the ML model may be further trained based on text inputs provided by users at various game states, to learn to predict likely inputs (speech or otherwise) by users at different game states. The text inputs may be easier to obtain than speech inputs and can act as proxies for speech inputs and user inputs more generally.

In some cases, the intended speech input of the first user may be further determined based on one or more audio signals from the first user corresponding to the lip movements of the first user. This can be useful in quiet or noisy conditions where the first user's input audio signal can be detected but is too faint (in of itself or relative to the ambient sound) to be understood by the second user. In such cases, the faint audio signal can be complemented with the lip movement and game state data to determine an intended speech input by the first user that can then be output to the second user. The first user audio signals user may for example be received from a microphone on the device of the first user.

The audio signals from the first user may be used for validating the output of the ML model. For example, the ML model may output a plurality of likely intended speech inputs by the first user (e.g. the top three or five most likely intended speech inputs) in dependence on input data relating to lip movements of the first user, and the game state. The intended speech input by the first user for output may then be selected from the plurality of most likely intended speech inputs in dependence on the audio signals.

Alternatively, or in addition, the audio signals from the first user may be provided as further inputs to the ML model, e.g. as part of an input feature vector.

Alternatively, or in addition, the audio signals may be used in selecting one of a plurality of ML models for determining the intended speech input; for instance, a predetermined mapping may be provided between audio characteristics of the audio signals from the first user and corresponding ML models.

A step 208 comprises generating an audio signal corresponding to the intended speech input by the first user.

Generating the audio signal may comprise using a generative machine learning model to convert the intended speech input by the first user to an audio signal. The generative machine learning model may for example use any of the generative artificial intelligence (AI) techniques described herein. Generating the audio signal using generative AI allows generating a realistic audio signal that imitates a speech input by another user, thus facilitating intuitive ‘voice chat like’ communication between the first user and other users.

To further facilitate realism of the communication and the immersiveness of the game, the audio signal may be generated in dependence on the detected game state. For example, properties of the audio signal, such as pitch, volume, or speed, may be modified in dependence on the game state. For instance, the audio signal may be modified to imitate a whisper when the first user is playing a stealth-type game or aiming to achieve a stealth objective (e.g. sneaking up behind enemy lines in a first person shooter game). Alternatively, or in addition, the audio signal may be modified in dependence on character data relating to one or more characteristics of an in-game character being controlled by the first user; for instance, to imitate a voice expected for that character. Alternatively, or in addition, the audio signal may be modified in dependence on profile data relating to a gaming profile of the first user; for instance, to imitate an accent associated with a nationality of the first user.

The modifications to the audio signal may be implemented as an input (e.g. emotional classification or rating) input to the generative AI model. Alternatively, or in addition, the modifications may be implemented as post-processing on an audio signal generated by the generative AI model.

Alternatively, or in addition, generating the audio signal may comprise selecting one of a plurality of generative AI models for generating the audio signal in dependence on the detected game state. The generative AI model may be selected based on a predetermined mapping between game states and generative AI models. For example, each in-game character that can be controlled by the first user may have an associated generative AI model.

In some cases, the generative AI model may be further, or alternatively, selected from a plurality of generative machine learning models for generating the audio signal, in dependence on one or more speech samples received from the first user. For example, a generative AI model that is a closest match (e.g. with regards to voice characteristics) to the speech samples may be selected. This allows further improving the realism of the communication as the generated audio signal more closely mimics real speech of the first user. Switching by the first user from conventional voice chat to the techniques described herein may in this way be less, and in some cases not at all, noticeable to other users.

To facilitate the understanding of the audio signal by a given receiving user (i.e. the second user), the audio signal may be generated in dependence on one or more characteristics of the second user. These characteristics may for example include one or more of: nationality, spoken languages and/or proficiency in these languages, age, and/or accessibility needs (e.g. learning or hearing disorders). For instance, the volume of the audio signal may be increased and/or the speed of the speech in the audio signal may be reduced for second users with accessibility needs. Alternatively, or in addition, for instance the intended speech input may be translated to the second user's mother tongue and the audio signal may be generated for the translated intended speech input.

Alternatively, or in addition, to generating the audio signal using generative AI, the audio signal may be generated using other audio processing techniques such as phonetic transcription, e.g. using grapheme-to-phoneme conversion (G2P).

As discussed elsewhere herein, the audio signal may be generated at the transmitting (e.g. first user) device and/or at the receiving (e.g. second user) device.

A step 210 comprises outputting the audio signal to a device of a second user of the plurality of users. Outputting the audio signal may comprise transmitting the audio signal to the second user device.

Alternatively, outputting the audio signal may comprise transmitting the audio signal to the second user device (e.g. as a text file), and the audio signal may be generated and output by the second user device. In other words, outputting the audio signal may comprise outputting (e.g. a loudspeaker) the audio signal by the second user device.

From the viewpoint of the second user, their device outputs an audio file corresponding to a speech input by the first user. The background processing of determining the intended speech input and generating the corresponding audio signal is hidden from the second user. The first and second user can therefore communicate in a manner closely imitating audio chat, which facilitates their communication without distracting from gameplay and retaining a sense of immersion for both users. In some cases, the audio signal is generated in such a way as to further enhance the sense of immersion (e.g. by generating the audio signal based on game data as described herein) and/or to further facilitate understanding of the communication by the second user thus increasing the accessibility of the communication to variously impaired users.

In some cases, determining the intended speech input at step 206 may comprise determining, in dependence on the game state, a probability of the intended speech input by the first user determined by the ML model. Generating and outputting the audio signal corresponding to the intended speech input at steps 208 and 210 may then be performed only if the probability of the determined intended speech input by the first user is above a predetermined threshold. In other words, the ML model may determine the intended speech input in dependence on the lip movement data (and optionally game state data), and a further validation step on the ML model's output may be performed before that output is converted to an audio file and output to the second user. This allows improving the security of the communication between the first and second users. For instance, this allows filtering out inputs that may have been provided (e.g. mouthed) by the first user without the intention for them being shared with other users, and preventing such inputs from being transmitted to the other users. For instance, the first user may mouth to themselves or have tics that they do not wish to be transmitted as messages to other users. Determining the probability of the speech input determined at step 206 based on game state allows identifying inputs that are less, or un-, related to the gameplay and preventing the transmission of corresponding messages. In this way, users do not need to change their habits and behaviour from conventional audio chat (e.g. they do not need to control their tics), without worrying about unintentional audio signals being generated and transmitted to other users.

In some cases, a form of ‘silent’ voice control may be implemented based on the determined intended speech input of the first user. This provides a new form of input for users, and can further improve accessibility of the game by allowing speech impaired users to control the game without providing manual inputs (e.g. using a mouse and keyboard or games controller). For example, the first user may use their lip movements to control their in-game character, where an-in game character controlled by the first user may be caused to perform one or more actions (e.g. jump or initiate an attack) in dependence on the determined intended speech input by the first user. Alternatively, or in addition, the intended speech input may be used to control the game more generally, e.g. to pause the game or navigate the game menu.

Referring back to FIG. 2, in a summary embodiment of the present invention an audio processing method, for assisting communication between a plurality of users of a videogame, comprises the following steps.

A step 202 comprises receiving, from one or more sensors, data relating to one or more lip movements of a first user of the plurality of users, as described elsewhere herein.

A step 204 comprises detecting a game state of the videogame, as described elsewhere herein.

A step 206 comprises determining, using a machine learning model, an intended speech input by the first user in dependence on: the data relating to lip movements of the first user, and the game state, as described elsewhere herein.

A step 208 comprises generating an audio signal corresponding to the intended speech input by the first user, as described elsewhere herein.

A step 210 comprises outputting the audio signal to a device of a second user of the plurality of users, as described elsewhere herein.

It will be apparent to a person skilled in the art that variations in the above method corresponding to operation of the various embodiments of the method and/or apparatus as described and claimed herein are considered within the scope of the present disclosure, including but not limited to that:
the data relating to lip movements comprises data relating to movements of the lips and tongue of the user, as described elsewhere herein;
the one or more sensors comprise one or more selected from the list consisting of: an image sensor, a depth sensor, an electrical sensor, a motion sensor, and an infrared sensor, as described elsewhere herein;
the step 208 of generating the audio signal comprises using a generative machine learning model to convert the intended speech input by the first user to an audio signal, as described elsewhere herein;
the step 208 of generating the audio signal comprises generating the audio signal in dependence on one or more characteristics of the second user, as described elsewhere herein;
the step 208 of generating the audio signal comprises generating the audio signal in dependence on the detected game state, as described elsewhere herein;
   in this case, optionally, the step 208 of generating the audio signal comprises selecting one of a plurality of generative machine learning models for generating the audio signal in dependence on the detected game state, as described elsewhere herein;
   in this case, optionally, the audio signal is generated in dependence on character data relating to one or more characteristics of an in-game character being controlled by the first user, as described elsewhere herein;
   in this case, optionally, the audio signal is generated in dependence on profile data relating to a gaming profile of the first user, as described elsewhere herein;
the method further comprises receiving one or more speech samples from the first user, where generating the audio signal corresponding to the intended speech input by the first user comprises selecting one of a plurality of generative machine learning models for generating the audio signal in dependence on the received speech samples, as described elsewhere herein;
the method further comprises causing an in-game character controlled by the first user to perform one or more actions in dependence on the determined intended speech input by the first user, as described elsewhere herein;
the step 206 of determining the intended speech input by the first user comprises inputting the data relating to lip movements of the first user, and the game state to the machine learning model, the machine learning model being trained to determine an intended speech input of a user, as described elsewhere herein;
the step 206 of determining the intended speech input by the first user comprises determining a plurality of likely intended speech inputs by the first user in dependence on the data relating to lip movements of the first user, and selecting the intended speech input amongst the plurality of likely intended speech inputs in dependence on the game state, as described elsewhere herein;
the step 206 of determining the intended speech input by the first user comprises selecting one of a plurality of machine learning models for determining an intended speech input of a user, in dependence on the game state; and inputting the data relating to lip movements of the first user to the selected machine learning model to determine the intended speech input by the first user, as described elsewhere herein;
the step 206 of determining the intended speech input by the first user comprises selecting one of a plurality of machine learning models for determining an intended speech input of a user, in dependence on a facial profile of the first user; and inputting the data relating to lip movements of the first user, and the game state to the machine learning model to determine the intended speech input by the first user, as described elsewhere herein;
   in this case, optionally, selecting the one of the plurality of machine learning models comprises: receiving one or more images of the first user's face; determining a facial profile of the first user in dependence on the received images of the first user's face; and selecting the one of the plurality of machine learning models at least partly in dependence on the facial profile of the first user, as described elsewhere herein;
the machine learning model is trained with training data comprising: data relating to speech inputs of a plurality of users of videogames at a plurality of game states, and data relating to lip movements of the plurality of users when providing the speech inputs, as described elsewhere herein;
   In this case, optionally, the training data comprises: a first training data comprising, for a first plurality of users of videogames, data relating to speech inputs of the users at a plurality of game states, for training the machine learning model to predict a speech input in dependence on a game state; and a second training data comprising, for a second plurality of users of videogames, data relating to speech inputs of the users at a plurality of game states and data relating to lip movements of the users when providing the speech inputs, for training the machine learning model to predict a speech input in dependence on lip movements of a user and a game state; where the second plurality of users comprise fewer users than the first plurality of users, as described elsewhere herein;
   In this case, optionally, training the machine learning model comprises: a first training step of training the machine learning model with first training data comprising, for a first plurality of users of videogames, data relating to speech inputs of the users at a plurality of game states, to predict a speech input in dependence on a game state; a second training step of training the machine learning model with second training data comprising, for a second plurality of users of videogames, data relating to speech inputs of the users at a plurality of game states and data relating to lip movements of the users when providing the speech inputs, to predict a speech input in dependence on lip movements of a user and a game state; wherein there are fewer users in the second plurality of users than in the first plurality of users, as described elsewhere herein;
the method further comprises: receiving, for a plurality of historical speech inputs by the first user, data relating to the speech inputs, and game states, and optionally lip movements of the first user, when providing the speech inputs; and re-training the machine learning model using the received data for the plurality of historical speech inputs by the first user; wherein the received data is assigned a higher weighting than other training data, as described elsewhere herein;
the game state detected at step 204 comprises one or more selected from the list consisting of: character data relating to one or more characteristics of an in-game character being controlled by the first user and/or by one or more other users of the plurality of users of the videogame; event data relating to one or more events that have occurred in gameplay of the videogame; position data relating to a position of one or more in-game characters and/or one or more in-game objects within a virtual environment of the video game; virtual camera data relating to a viewpoint of a virtual camera associated with the first user; interaction data relating to one or more in-game characters and/or in-game objects with which the first user has been interacting, either prior to or concurrently with the data relating to lip movements being received; objective data relating to one or more in-game objectives associated with the first user and/or one or more in-game objectives associated with one or more other users of the plurality of users; proficiency data relating to a proficiency with which the first user plays the video game and/or a proficiency with which one or more other users of the plurality of users play the video game; videogame data relating to at least one of a type of the videogame, a category of the videogame, and a genre of the videogame; and profile data relating to a gaming profile of the first user and/or gaming profiles of one or more other users of the plurality of users, as described elsewhere herein;
the data received from the one or more sensors at step 202 further comprises data relating to facial expressions and/or body language of the first user; and the intended speech input by the first user is determined further in dependence on the data relating to facial expressions and/or body language of the first user, as described elsewhere herein;
the step 206 of determining the intended speech input by the first user comprises determining a sentiment of the first user in dependence on the lip movement data received from the one or more sensors, and providing the determined sentiment of the first user as an input to the machine learning model, as described elsewhere herein;
the step 206 of determining the intended speech input by the first user comprises determining, in dependence on the game state, a probability of the intended speech input by the first user determined by the machine learning model, as described elsewhere herein; in this case, optionally, generating and outputting the audio signal corresponding to the intended speech input is performed if the determined probability is above a predetermined threshold, as described elsewhere herein;
the method further comprises receiving one or more audio signals corresponding to the lip movements of the first user; wherein the intended speech input by the first user is determined further in dependence on the received audio signals, as described elsewhere herein;
   in this case, optionally, the machine learning model outputs a plurality of likely intended speech inputs by the first user in dependence on input data relating to lip movements of the first user, and the game state; and an intended speech input by the first user is selected from the plurality of likely intended speech inputs in dependence on the audio signals, as described elsewhere herein;
the step 204 of detecting the game state comprises receiving game state data for the videogame, as described elsewhere herein;
the method further comprises determining a sentiment of the first user in dependence on the data received from the one or more sensors; wherein the intended speech input by the first user is determined further in dependence on the determined sentiment of the first user, as described elsewhere herein;
the method further comprises determining a probability of the determined intended speech input by the first user in dependence on the game state, and generating and outputting the corresponding audio signal if the probability is above a predetermined threshold, as described elsewhere herein;
the method further comprises capturing data relating to one or more lip movements of a first user of the plurality of users using one or more sensors, as described elsewhere herein; and
the method is computer-implemented, as described elsewhere herein.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Hence referring back to FIG. 1, an example conventional device may be the entertainment system 10, Accordingly, an audio processing system 10 for assisting communication between a plurality of users of a videogame, may comprise the following.

A communication processor (for example CPU 20) configured (for example by suitable software instruction) to receive, from one or more sensors, data relating to one or more lip movements of a first user of the plurality of users, as described elsewhere herein. A detection processor (for example CPU 20) configured (for example by suitable software instruction) to detect a game state of the videogame, as described elsewhere herein. A machine learning model (for example deployed on the CPU 20) configured (for example by suitable software instruction) to determine an intended speech input by the first user in dependence on: the data relating to lip movements of the first user, and the game state, as described elsewhere herein. An audio generation processor (for example CPU 20) configured (for example by suitable software instruction) to generate an audio signal corresponding to the intended speech input by the first user, as described elsewhere herein. An output processor (for example CPU 20) configured (for example by suitable software instruction) to output the audio signal to a device of a second user of the plurality of users, as described elsewhere herein.

In another summary embodiment of the present invention, a method of training a machine learning model for use in audio processing comprises the following steps.

A step of receiving training data comprising:

data relating to speech inputs of a plurality of users of videogames at a plurality of game states, and
data relating to lip movements of the plurality of users when providing the speech inputs, as described elsewhere herein.

And a step of inputting the training data to a machine learning model to train the machine learning model to determine an intended speech input by the first user, in dependence on: the data relating to lip movements of the first user, and the game state, as described elsewhere herein.

The machine learning model trained according to this method may be for use in the audio processing method as described elsewhere herein. The machine learning model may be trained using supervised learning. The machine learning model may be trained using training data and/or training steps as described elsewhere herein.

In another summary embodiment of the present invention, a trained machine learning model for use in audio processing comprises one or more learned parameters for determining an intended speech input by the first user in dependence on: the data relating to lip movements of the first user, and the game state.

The machine learning model may be trained as described elsewhere herein. The machine learning model may be for use in the audio processing method as described elsewhere herein.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An audio processing method comprising:
receiving, from one or more sensors, lip movement data relating to one or more lip movements of a first user of a plurality of users of a videogame;
detecting a game state of the videogame;
determining, using a machine learning model, an intended speech input associated with the first user based on the lip movement data and the game state;
generating an audio signal corresponding to the intended speech input associated with the first user; and
outputting the audio signal to a device of a second user of the plurality of users.

2. The audio processing method of claim 1, wherein generating the audio signal corresponding to the intended speech input associated with the first user comprises using a generative machine learning model to convert the intended speech input associated with the first user to the audio signal.

3. The audio processing method of claim 1, wherein generating the audio signal corresponding to the intended speech input associated with the first user comprises generating the audio signal based at least in part on one or more characteristics of the second user.

4. The audio processing method of claim 1, wherein generating the audio signal corresponding to the intended speech input associated with the first user comprises generating the audio signal based at least in part on the game state.

5. The audio processing method of claim 1, further comprising causing an in-game character controlled by the first user to perform one or more actions based at least in part on the intended speech input associated with the first user.

6. The audio processing method of claim 1, wherein determining the intended speech input associated with the first user comprises inputting the lip movement data, and the game state to the machine learning model, the machine learning model being trained to determine-intended speech input.

7. The audio processing method of claim 1, wherein determining the intended speech input associated with the first user comprises determining a plurality of likely intended speech inputs by the first user based at least in part on the lip movement data, and selecting the intended speech input amongst the plurality of likely intended speech inputs based at least in part on the game state.

8. The audio processing method of claim 1, further comprising:
selecting, based at least in part on the game state, the machine learning model from a plurality of machine learning models for determining the intended speech input; and
inputting the lip movement data to the machine learning model to determine the intended speech input associated with the first user.

9. The audio processing method of claim 1, wherein the machine learning model is trained with training data comprising: data relating to speech inputs of a plurality of users of videogames at a plurality of game states, and second lip movement data relating to lip movements of the plurality of users when providing the speech inputs.

10. The audio processing method of claim 9, wherein the training data comprises:
a first training data comprising, for a first plurality of users of videogames, first data relating to first speech inputs of the users at a first plurality of game states, for training the machine learning model to predict a first speech input based at least in part on a first game state; and
a second training data comprising, for a second plurality of users of videogames, second data relating to second speech inputs of the users at a second plurality of game states and data relating to lip movements of the users when providing the second speech inputs, for training the machine learning model to predict a second speech input based at least in part on lip movements and a second game state;
wherein the second plurality of users comprise fewer users than the first plurality of users.

11. The audio processing method of claim 1, wherein the game state comprises one or more of:
character data relating to at least one of one or more characteristics of an in-game character being controlled by the first user or by one or more other users of the plurality of users of the videogame;
event data relating to one or more events that have occurred in gameplay of the videogame;
position data relating to a position of one or more in-game characters and/or one or more in-game objects within a virtual environment of the videogame;
virtual camera data relating to a viewpoint of a virtual camera associated with the first user;
interaction data relating to at least one of one or more in-game characters or in-game objects with which the first user has been interacting, either prior to or concurrently with the lip movement data being received;
objective data relating to one or more in-game objectives associated with at least one of the first user or one or more in-game objectives associated with one or more other users of the plurality of users;
proficiency data relating to at least one of a first proficiency with which the first user plays the videogame or a second proficiency with which one or more other users of the plurality of users play the videogame;
videogame data relating to at least one of a type of the videogame, a category of the videogame, and a genre of the videogame; or
profile data relating to at least one of a gaming profile of the first user or gaming profiles of another uses another user of the plurality of users.

12. The audio processing method of claim 1, wherein determining the intended speech input associated with the first user comprises determining, based at least in part on the game state, a probability of the intended speech input associated with the first user determined by the machine learning model, and wherein generating and outputting the audio signal corresponding to the intended speech input is performed if the probability is above a predetermined threshold.

13. The audio processing method of claim 12, wherein determining the intended speech input associated with the first user comprises determining, in dependence on the game state, a probability of the intended speech input associated with the first user determined by the machine learning model, and wherein generating and outputting the audio signal corresponding to the intended speech input is performed if the probability is above a predetermined threshold.

14. (canceled)

15. A system comprising:
one or more storage media storing instructions; and
one or more processors configured to execute the instructions to cause the system to:
receive, from one or more sensors, lip movement data relating to one or more lip movements of a first user of a plurality of users of a videogame;
detect a game state of the videogame;
determine, by a machine learning model an intended speech input associated with the first user based on the lip movement data and the game state;
generate an audio signal corresponding to the intended speech input associated with the first user; and
output the audio signal to a device of a second user of the plurality of users.

16. The system of claim 15, wherein the game state comprises character data relating to at least one of one or more characteristics of an in-game character being controlled by the first user or by one or more other users of the plurality of users of the videogame.

17. The system of claim 15, wherein the game state comprises position data relating to a position of one or more in-game characters and/or one or more in-game objects within a virtual environment of the videogame.

18. One or more non-transitory computer-readable storage media storing instructions that, upon execution by one or more processors of a system, cause the system to perform operations comprising:
receiving, from one or more sensors, lip movement data relating to one or more lip movements of a first user of a plurality of users of a videogame;
detecting a game state of the videogame;
determining, using a machine learning model, an intended speech input associated with the first user based on the lip movement data of the first user and the game state;
generating an audio signal corresponding to the intended speech input associated with the first user; and
outputting the audio signal to a device of a second user of the plurality of users.

19. The non-transitory computer-readable storage media of claim 18, wherein the game state comprises virtual camera data relating to a viewpoint of a virtual camera associated with the first user.

20. The non-transitory computer-readable storage media of claim 18, wherein the game state comprises interaction data relating to at least one of one or more in-game characters or in-game objects with which the first user has been interacting, either prior to or concurrently with the lip movement data being received.

21. The non-transitory computer-readable storage media of claim 18, wherein the game state comprises videogame data relating to at least one of a type of the videogame, a category of the videogame, and a genre of the videogame.
